(19) United States
(12) Patent Application Publication
(10) Pub. No.: US 2024/0050971 A1
(43) Pub. Date: Feb. 15, 2024

(54) Pre-compression pump capable of reducing height and preventing seepage and container having same

(71) Applicants: Fei Cheng, Shenzhen (CN); Weidong Kang, Shenzhen (CN)

(72) Inventors: Fei Cheng, Shenzhen (CN); Weidong Kang, Shenzhen (CN)

(21) Appl. No.: 18/223,561

(22) Filed: Jul. 19, 2023

(30) Foreign Application Priority Data
Aug. 15, 2022 (CN) 202210977248.8

(51) Int. Cl. B05B 11/10; B05B 11/00

(52) U.S. Cl. CPC B05B 11/1047; B05B 11/0037; B05B 11/1073; B05B 11/1087

(57) ABSTRACT

A pre-compression pump includes a main body, a first piston assembly movably mounted in the main body, a head assembly on a top of the first piston assembly, a second piston in the first piston assembly, and a second spring supported between the second piston and the first piston assembly. A water storage sump is disposed between the main body and the first piston assembly. A water outlet channel is disposed in the inner part of the first piston assembly. The water outlet channel is connected to the water storage sump and a nozzle of the head assembly. The second piston has an ejector pin portion for sealing the water outlet channel.

### BACKGROUND OF THE INVENTION

### 1. Field of the Invention

The invention relates to pre-compression pumps and more particularly to a pre-compression pump capable of reducing height and preventing seepage and a container with such pump.

### 2. Description of Related Art

A pre-compression pump is usually mounted on a container and used to spray various liquids stored in the container, such as perfumes, pharmaceutical products, cosmetics, cleaning products, and the like. Generally, the pre-compression pump is a device that sprays liquid outward only when liquid in a water storage sump is under a specific minimum pressure. This manner may ensure that the liquid is sprayed outward at a higher pressure, with a better spraying effect.

There are various pre-compression pumps with diverse structure in conventional art. For example, a conventional pre-compression pump has a water storage sump that is disposed between a piston and a main body. The piston squeezes the water storage sump while a main column moves down, and a pressure in the water storage sump increases. When the pressure increases and even exceeds a preset force of a spring on the piston, the piston is jacked upward. In this case, a sealing part leaves an amplification cap, a channel is opened, and the liquid enters the channel and moves upward until the liquid is sprayed outward from a nozzle. When the pressure cannot meet an atomization condition, the liquid is not seeped outward due to this structure. Because of a large area of a pressure surface, in contact with the liquid, of the piston is large. After the piston is stressed, a displacement of the piston is short, and the spraying effect is poor.

Therefore, how to design a pre-compression pump capable of effectively improving the spraying effect and a container is an urgent technical problem to be resolved in the art.

### SUMMARY OF THE INVENTION

In order to resolve the above problems in the prior art, the invention provides a pre-compression pump capable of reducing a height and preventing seepage and a container with such pump. According to the invention, because components such as a second piston and a second spring are disposed in an inner part of a first piston assembly, a spraying effect of the pre-compression pump is better and an overall height is shorter.

The invention adopts the following technical solutions: A pre-compression pump capable of reducing a height and preventing seepage is designed. The pre-compression pump includes: a main body, a first piston assembly that is movably mounted in an inner part of the main body, a head assembly that is disposed on a top of the first piston assembly, a second piston that is disposed in an inner part of the first piston assembly, and a second spring that is supported between the second piston and the first piston assembly. A water storage sump is disposed between the main body and the first piston assembly, a water outlet channel is disposed in the inner part of the first piston assembly, the water outlet channel is connected to the water storage sump and a nozzle of the head assembly; and the second piston has an ejector pin portion that is used to seal the water outlet channel.

Preferably, the first piston assembly comprises: a first piston that is movably disposed in the inner part of the main body, a spring holder that is mounted in an inner part of the first piston, and a first spring that is supported between the main body and the spring holder. Space between the first piston and the main body is the water storage sump, and the water storage sump is designed in the inner part of the first piston, to reduce an overall height of the pre-compression pump to the greatest extent. The second piston is movably disposed in the spring holder, the second spring is supported between the spring holder and the second piston, space between an upper side of the second piston and the first piston is a variable pressure silo, and the variable pressure silo is connected to the water storage sump. When the first piston is displaced and the water storage sump is under a pressure, the second piston is greatly displaced in a variable pressure silo with a smaller diameter. Therefore, the pre-compression pump avoids a seepage process, and directly sprays liquid with better performance.

Preferably, space between an underside of the second piston and the spring holder is a compression silo, the second piston comprises an internal elastic extension portion that extends outward, an outer edge of the internal elastic extension portion is in contact with an inner wall of the spring holder, to seal the compression silo.

Preferably, a side wall of the main body is provided with an exhaust hole, an outer edge of a bottom of the first piston extends outward to form a lower elastic extension portion that is used to seal the water storage sump, an exhaust adjusting rib that is disposed beneath the lower elastic extension portion is disposed in the inner part of the main body, and when moving downward and touching the exhaust adjusting rib, the lower elastic extension portion is deformed, to discharge air in an inner part of the water storage sump to the outside.

Preferably, a top of the main body is provided with an open, a collar piece is fastened and mounted in the open, the collar piece is sleeved in a center hole on the first piston, the first piston has a tapered segment of which size increases from top to bottom, and the center hole is in contact with the tapered segment to form a line seal, to ensure that liquid in a container does not leak under vibration and a specific negative pressure.

Preferably, an outer edge of the top of the first piston expands outward to form an upper elastic extension portion, an outer edge of the upper elastic extension portion is in contact with an inner wall of the main body for sealing, an air intake slot is disposed at the top of the main body, and the upper elastic extension portion moves downward to the air intake slot with the first piston. Therefore, air in an external environment may flow, from a gap between the collar piece and the first piston, between the upper elastic extension portion and the lower elastic extension portion through the air intake slot, and then may enter the container through the exhaust hole of the main body, to maintain a pressure in the container the same as that of the external environment. This ensures that the pump is continuously used.

Preferably, the water outlet channel is disposed in the inner part of the first piston and above the second piston, the ejector pin portion is disposed at a top of the second piston, at least one step is disposed at one end, close to the second piston, of the water outlet channel, a size of the ejector pin portion increases from top to bottom, and an edge of each step is in contact with the ejector pin portion, to form a line seal, to prevent seepage when a pressure of the pump is insufficient.

Preferably, the main body has a water inlet channel that is connected to the water storage sump, a one-way ball valve is disposed at a top of the water inlet channel and a suction pipe is connected to a bottom of the water inlet channel, an outer periphery of the one-way ball valve is enclosed by at least three limiting ribs that are disposed at intervals, and the one-way ball valve moves up and down in space that is enclosed by the limiting ribs. Due to a gap between the limiting ribs, the liquid in the container can more smoothly enter the water storage sump.

The invention further provides a container. The container includes a bottle. The pre-compression pump is mounted on the bottle.

Preferably, the bottle has a bayonet, the main body is mounted in an inner part of the bayonet, and the collar piece is fixedly mounted on the top of the main body, and a fixing sleeve that clamps and fastens the collar piece in the bayonet is coated at an outer ring of the bayonet, to prevent the pre-compression pump from falling off from the bottle and loosening.

The invention has the following advantages and benefits in comparison with the conventional art: the second piston and the second spring are mounted in the inner part of the first piston assembly, and the variable pressure silo is designed between the first piston assembly and the second piston. When a pressure of the water storage sump does not reach a specific value, the water outlet channel is sealed by the ejector pin portion of the second piston. When a pressure on the second piston can overcome a pre-pressure of the second spring, the second piston moves downward to open a channel with a larger displacement. In this case, there is a large pressure of pumping the liquid outside, so that a spraying effect is effectively optimized. Further, because the variable pressure silo is disposed in the inner part of the first piston, a height can be reduced to a greatest extent.

The above and other objects, features and advantages of the invention will become apparent from the following detailed description taken with the accompanying drawings.

### BRIEF DESCRIPTION OF THE DRAWINGS

FIG. 1 is a longitudinal sectional view of a pre-compression pump according to the invention;

FIG. 2 is an exploded view of the pre-compression pump;

FIG. 3 is a longitudinal sectional view of a bottle incorporating the pre-compression pump;

FIG. 4 is a view similar to FIG. 1 showing air in the pre-compression pump being completely expelled by the pre-compression pump;

FIG. 5 is a view similar to FIG. 4 showing liquid being sucked by the pre-compression pump; and

FIG. 6 is a view similar to FIG. 5 showing the pre-compression pump spraying.

### DETAILED DESCRIPTION OF THE INVENTION

The pre-compression pump provided in the invention is appropriately mounted on a container for storing liquid. The liquid in the container can be sucked up and sprayed outward by pressing the pre-compression pump.

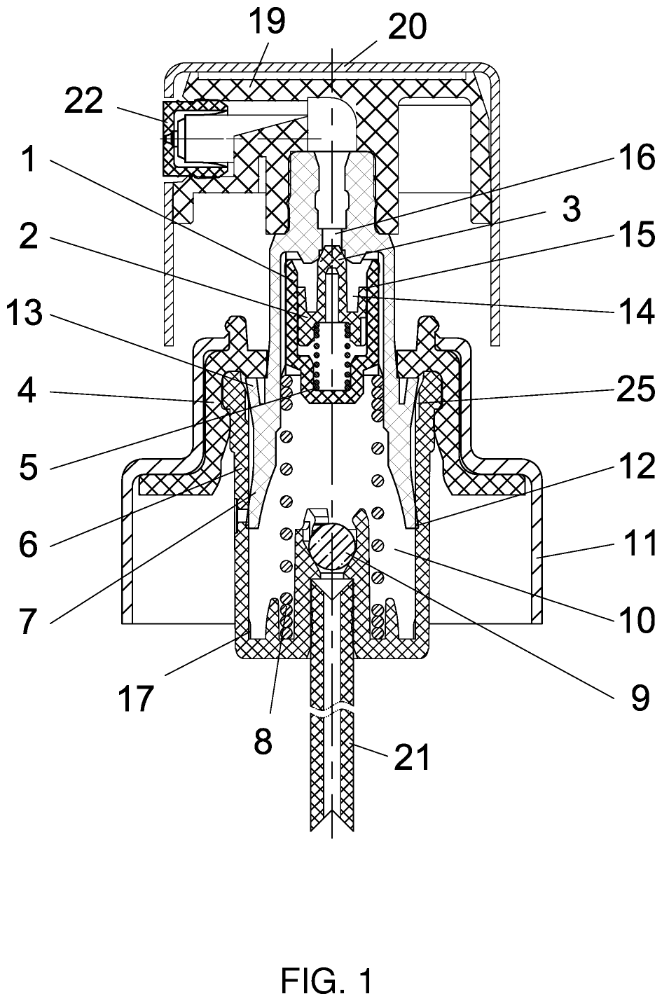

Referring to FIGS. 1 to 6, a pre-compression pump of the invention comprises main components such as a main body 6, a first piston assembly, a head assembly, a second piston 2, and a second spring 5. The first piston assembly is mounted in an inner part of the main body 6. The head assembly is mounted on a top of the first piston assembly. A water storage sump 10 is disposed between the first piston assembly and the main body 6, a water outlet channel 16 is disposed in the inner part of the first piston assembly, the water outlet channel 16 is connected to the water storage sump 10 and a nozzle 22 of the head assembly. Liquid in the water storage sump 10 may be sprayed outward from the nozzle 22 through the water outlet channel 16. The second piston 2 is mounted in the inner part of the first piston assembly, the second spring 5 is supported between the second piston 2 and the first piston assembly, and an ejector pin portion 3 is disposed on a top of the second piston 2. The second piston 2 is supported by an elastic force of the second spring 5, and the ejector pin portion 3 is pressed against a bottom of the water outlet channel 16 to close the water outlet channel 16. When a pressure on the second piston 2 overcomes a pre-pressure of the second spring 5, the second piston 2 moves downward, and the ejector pin portion 3 is separated from the water outlet channel 16 to open the water outlet channel 16. In the invention, the first piston assembly, the second piston 2, and the second spring 5 form a preloading piston assembly with a shorter overall height and a better spraying effect.

To better understand the pre-compression pump in the invention, a structure of each part of the pre-compression pump is described in detail below with reference to embodiments.

As shown in FIG. 1, the first piston assembly includes a first piston 7, a first spring 8, and a spring holder 1. The first piston 7 has a hollow inner part and is mounted in the main body 6. The water storage sump 10 is formed between an inner cavity of the first piston 7 and the main body 6. A volume of the water storage sump 10 varies while the first piston 7 moves up and down. The spring holder 1 is fixedly mounted in the inner part of the first piston 7, and just located below the water outlet channel 16. The first spring 8 is supported between the main body 6 and the spring holder 1. The first spring 8 provides an upward supporting force to the spring holder 1, which is equivalent to the spring holder 1 and the first spring 8 are located in the water storage sump 10. Spacing through which the liquid passes is disposed between the spring holder 1 and an inner wall of the first piston 7.

The spring holder 1 is provided with an accommodating cavity with an opening. The second piston 2 is movably disposed in the accommodating cavity of the spring holder 1. Space between the top of the second piston 2 and the first piston 7 is a variable pressure silo 14. A volume of the variable pressure silo 14 varies while the second piston 2 moves up and down. The variable pressure silo 14 is connected to the water storage sump 10, that is, the liquid in the water storage sump 10 may enter the variable pressure silo 14 above the second piston 2 through spacing between the spring holder 1 and the first piston 7.

An outer edge of the second piston 2 slightly extends outward to form an internal elastic extension portion 15. The internal elastic extension portion 15 is attached to the accommodating cavity of the spring holder 1. Space between an underside of the second piston 2 and the spring holder 1 is a compression silo. The compression silo and the variable pressure silo 14 are isolated through the internal elastic extension portion 15. The second spring 5 is located in the compression silo and supported between the second piston 2 and the spring holder 1. When a pressure of the variable pressure silo 14 increases, the second piston 2 overcomes the pre-pressure of the second spring 5 and moves downward, air in the compression silo and the second spring 5 are compressed, and the water outlet channel 16 is connected. When the pressure of the variable pressure silo 14 decreases, the second piston 2 is pushed upward under action of the compressed air and the second spring 5, and the water outlet channel 16 is closed. In comparison with a conventional pre-compression pump, space occupied by a new preloading piston assembly that is formed by designing the variable pressure silo 14, the second piston 2, and the second spring 5 in the inner part of the first piston assembly, the preloading piston assembly is reduced. This reduces an overall height of the pre-compression pump, so that a structure of the pre-compression pump is more compact.

The conventional pre-compression pump may achieve the spraying effect only when the liquid in the water storage sump reaches a specific minimum pressure and liquid begins to spray outward. However, in this case, because the pressure is small, the liquid is sprayed in a beeline or sprayed in a seepage manner. Only when the pressure is greater, a spraying effect of the liquid is better. The better spraying effect greatly depends on a pressing force of a user, and therefore, use experience is poor.

According to the pre-compression pump provided in the invention, seepage can be effectively avoided, and a working principle is as follows: To ensure the pressure on the second piston 2 in the variable pressure silo 14 reaches a specific minimum pressure, that is, the pre-pressure of the second spring 5, the head assembly needs to provide a larger pressure, and the second piston 2 moves a larger distance. When a transverse area that is of the first piston 7 and that is in contact with the liquid is S₁, a transverse area that is of the second piston 2 and that is in contact with the liquid is S₂, a movement distance of the first piston 7 is H₁, a movement distance of the second piston 2 is H₂, and the specific minimum pressure is Fₚᵣₑ, then a pressure Fₚᵣₑₛₛᵤᵣₑ that needs to be provided by the head assembly is Fₚᵣₑₛₛᵤᵣₑ=S₁/S₂×Fₚᵣₑ, and the movement distance H₂ of the second piston is H₂=S₁/S₂×H₁. This ensures that the liquid is not sprayed when the pressure is small. When the pressure is larger, the second piston 2 quickly opens a larger channel. The pre-compression pump avoids a seepage process, and directly sprays the liquid with better performance. Therefore, the use experience of the pre-compression pump is greatly optimized.

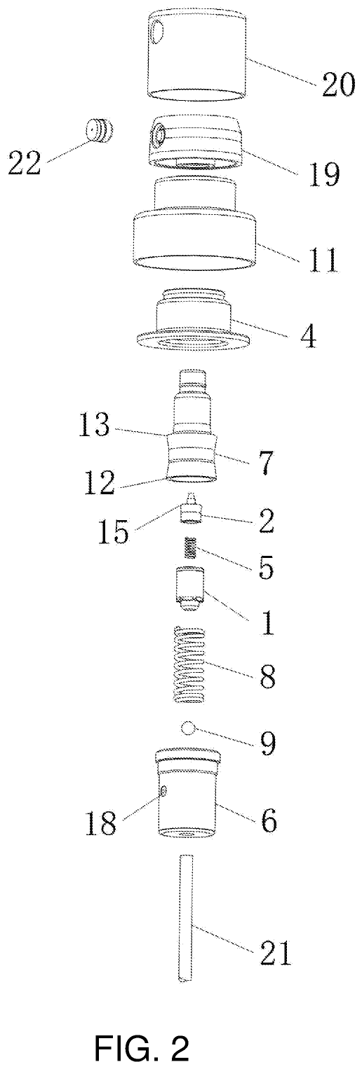

As shown in FIG. 1 and FIG. 2, the head assembly includes a nozzle 22, a head 19, and a head cap 20. The head 19 is mounted on the top of the first piston 7, and the head cap 20 covers above the head 19. The nozzle 22 is mounted in the head 19 from a side hole of the head cap 20. An inner end of the nozzle 22 is connected to the water outlet channel 16 through the head 19, and an outer end of the nozzle 22 is flush with an outer wall of the side hole of the head cap 20, to keep a beautiful shape of the head assembly. The water outlet channel 16 is disposed on the top of the first piston 7, and the water outlet channel 16 is located above the second piston 2. The ejector pin portion 3 is disposed at the top of the second piston 2. The ejector pin portion 3 may move up with the second piston 2 until the water outlet channel 16 is closed or may move down with the second piston 2 until the water outlet channel 16 is opened. At least one step is disposed at one end, close to the second piston 2, of the water outlet channel 16, a size of the ejector pin portion 3 increases from top to bottom, and an edge of each step is in contact with the ejector pin portion 3, to form a line seal. The edge of the step refers to a corner position at which the step protrudes toward the water outlet channel 16.

In some embodiments of the invention, there are two steps at the bottom of the water outlet channel 16. An inverted triangle is disposed at an edge of the water outlet channel 16 to form a first step, and a groove that is concaved upward is disposed at an edge of the first step to form a second step. Edges of the first step and the second step are in contact with the ejector pin portion 3 to form a line seal. Double line seals can effectively prevent the liquid in the water storage sump 10 from seeping outward and effectively prevent seepage when pressure of a pump body is small.

A water inlet channel 26 is disposed at a bottom of the main body 6, and a top of the water inlet channel 26 is located in and connected to the water storage sump 10. A one-way ball valve 9 is disposed at a top of the water inlet channel 26 and a suction pipe 21 is connected to a bottom of the water inlet channel 26. An outer periphery of the one-way ball valve 9 is enclosed by at least three limiting ribs that are disposed at intervals, and the one-way ball valve 9 moves up and down in space that is enclosed by the limiting ribs. Due to a gap between the limiting ribs, liquid in a container 100 can more smoothly enter the water storage sump 10.

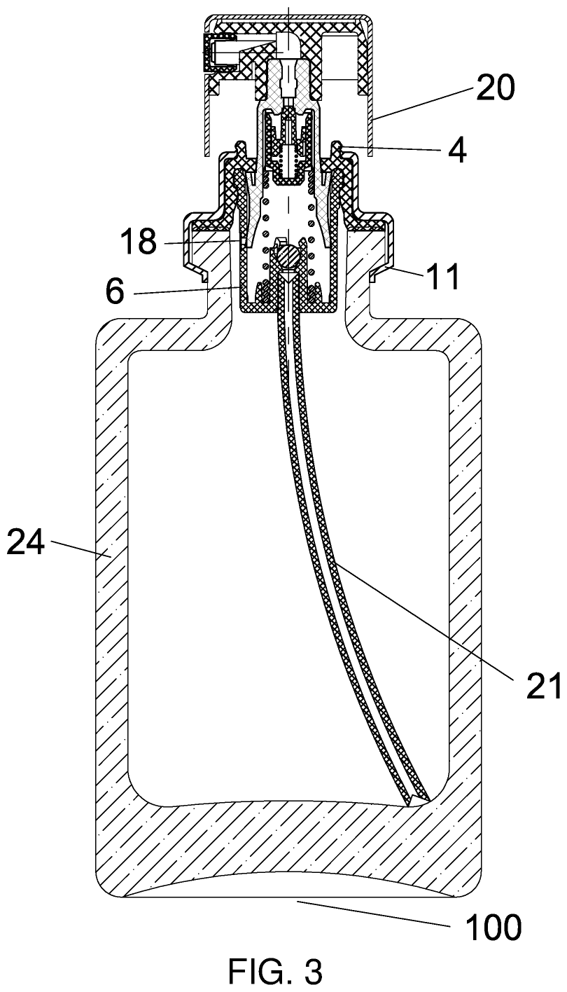

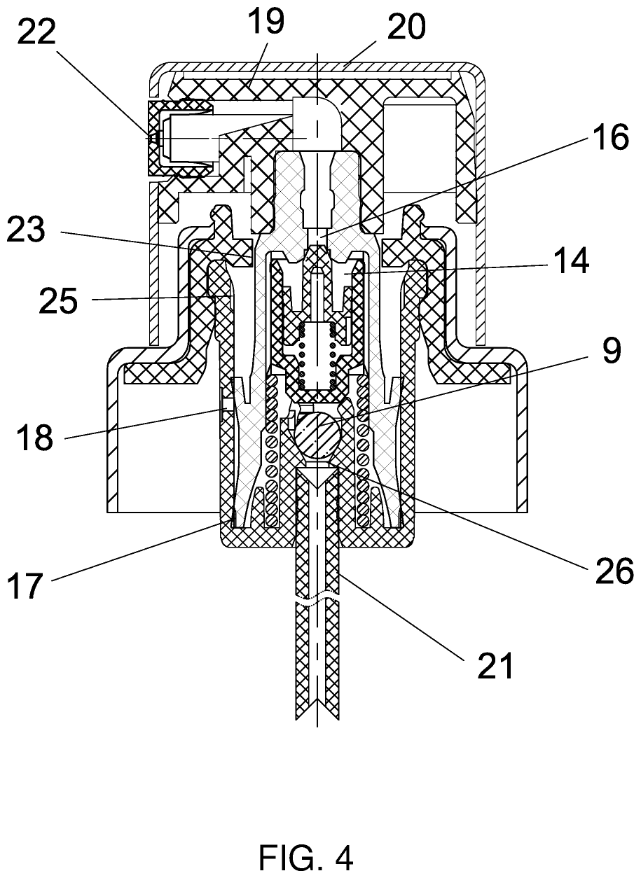

As shown in FIG. 3 and FIG. 4, a side wall of the main body 6 is provided with an exhaust hole 18. An outer edge of a bottom of the first piston 7 extends outward to form a lower elastic extension portion 12. The lower elastic extension portion 12 is in contact with an inner wall of the main body 6, to seal the water storage sump 10 between the first piston 7 and the main body 6. An exhaust adjusting rib 17 is disposed in the inner part of the main body 6. The exhaust adjusting rib 17 is located beneath the lower elastic extension portion 12. When the first piston 7 moves down to the lower elastic extension portion 12 and is in contact with the exhaust adjusting rib 17, the lower elastic extension portion 12 is deformed, and air in the water storage sump 10 overflows from a gap between the lower elastic extension portion 12 and the exhaust adjusting rib 17 and enters the container 100 from the exhaust hole 18. The pre-compression pump may obtain different ejection amounts by adjusting a length of the exhaust adjusting rib 17 of the main body 6. When the length of the exhaust adjusting rib 17 increases, a contact position between the first piston 7 and the exhaust adjusting rib 17 moves up, a sealing distance of the water storage sump 10 is shortened, and an amount of pumped liquid is correspondingly reduced.

A top of the main body 6 is provided with an open, a collar piece 4 is fastened and mounted in the open, the collar piece 4 is sleeved in a center hole on the first piston 7, and the first piston 7 has a tapered segment of which size increases from top to bottom. When not being compressed under an external force, the first piston 7 is located at an upper limit position under a supporting force of the first spring 8, and the tapered segment is in contact with the center hole to form a line seal, and isolate the inner part of the main body 6 from an external environment.

An outer edge of the top of the first piston 7 expands outward to form an upper elastic extension portion 13, and an outer edge of the upper elastic extension portion 13 is in contact with an inner wall of the main body 6 for sealing, to prevent the liquid in the water storage sump 10 from seeping outward. An air intake slot 25 is disposed at the top of the main body, and the upper elastic extension portion 13 moves downward to the air intake slot 25 with the first piston 7. In this case, the tapered segment of the first piston 7 leaves the center hole downward, and the exhaust hole 18 is located between the upper elastic extension portion 13 and the lower elastic extension portion 12. Therefore, air in the external environment may enter the main body 6 through a gap between the collar piece 4 and the first piston 7 and the air intake slot 25, and then enter the container 100 through the exhaust hole 18 of the main body 6. To be specific, when the pre-compression pump is pressed to spray the liquid outward, for reduced liquid in the container 100, outside air may be replenished into the container 100 through the exhaust hole 18, to avoid deformation of the container 100 or loss of functions of the pump body because of vacuum generated in an inner part of the container 100.

It should be noted that, the air in the external environment is replenished into the container 100 at beginning of a pressing process, the upper elastic extension portion 13 of the first piston 7 supplies air when passing through the air intake slot 25 downward or upward. After the upper elastic extension portion 13 moves out of the air intake slot, an outer edge of the upper elastic extension portion 13 is in contact and sealed with the inner wall of the main body 6 again, to ensure that the liquid in the water storage sump 10 does not seep outward.

Because the top of the main body 6 is open, various components such as the first spring 8, the one-way ball valve 9, the first piston 2, the spring holder 1, the second piston 2, and the second spring 5 may be mounted from the open during installation, and then the collar piece 4 is mounted and fastened with the main body 6. Therefore, not only the pre-compression pump may be easily assembled, but also the components are not scattered, and a structural stability is improved.

The following describes a usage process of the pre-compression pump in detail. As shown in FIG. 1 to FIG. 3, when the head assembly is pressed for the first time, the head assembly drives the preloading piston assembly to overcomes the pre-pressure of the first spring 8 and move downward. In this case, under the pre-pressure of the second spring 5, the second piston 2 is sealed with the first piston 7, and the one-way ball valve 9 is sealed with the main body 6. Under the action of the lower elastic extension portion 12, the first piston 7 is sealed with the main body 6, the preloading piston assembly slides down in cooperation with the main body 6, and air in the water storage sump 10 and the variable pressure silo 14 that are connected to each other is compressed while sealing space decreases. As shown in FIG. 4, when the preloading piston assembly moves down to the lower elastic extension portion 12 of the first piston 7 and is in contact with the exhaust adjusting rib 17 in the main body 6, the lower elastic extension portion 12 is elastically deformed, and the compressed air in the water storage sump 10 is discharged from the exhaust adjusting rib 17 and then discharged through the exhaust hole 18 on a side surface of the main body 6.

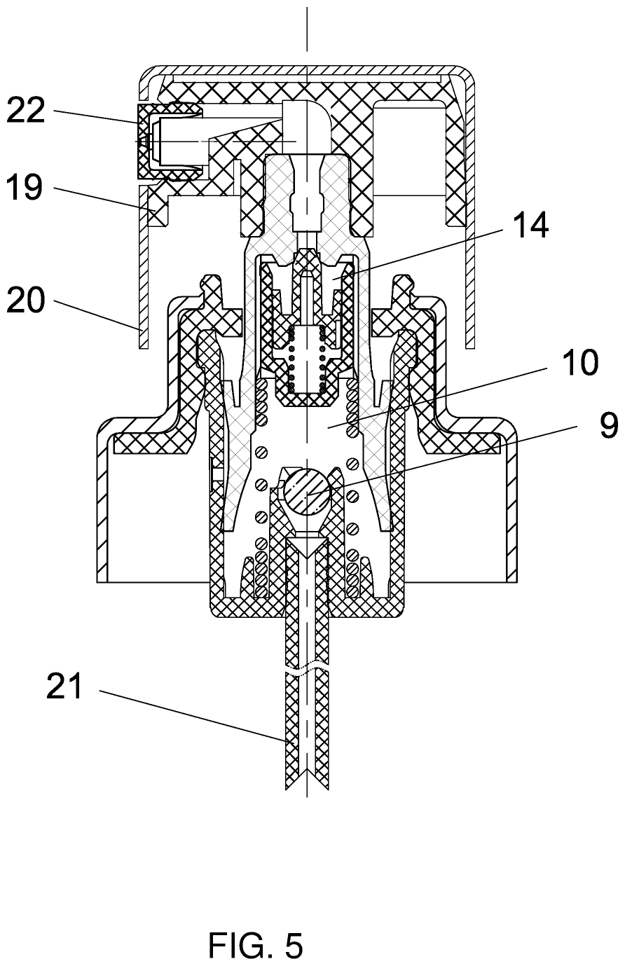

After the head assembly is released, the head assembly and the preloading piston assembly start to move up under action of a rebound force of the first spring 8. In this case, the first piston 7 is separated from the exhaust adjusting rib 17 disposed in the main body 6, the lower elastic extension portion 12 is re-attached to the inner wall of the main body 6, and connection space between the water storage sump 10 and the variable pressure silo 14 are sealed again. As shown in FIG. 5, while the preloading piston assembly moves up, the sealing space becomes larger to form vacuum. In this case, the liquid in the container passes the one-way ball valve 9 and then enters the water storage sump 10 through the suction pipe 21 under action of the vacuum. After the foregoing pressing process is repeated several times, all air in the sealing space is replaced by the liquid.

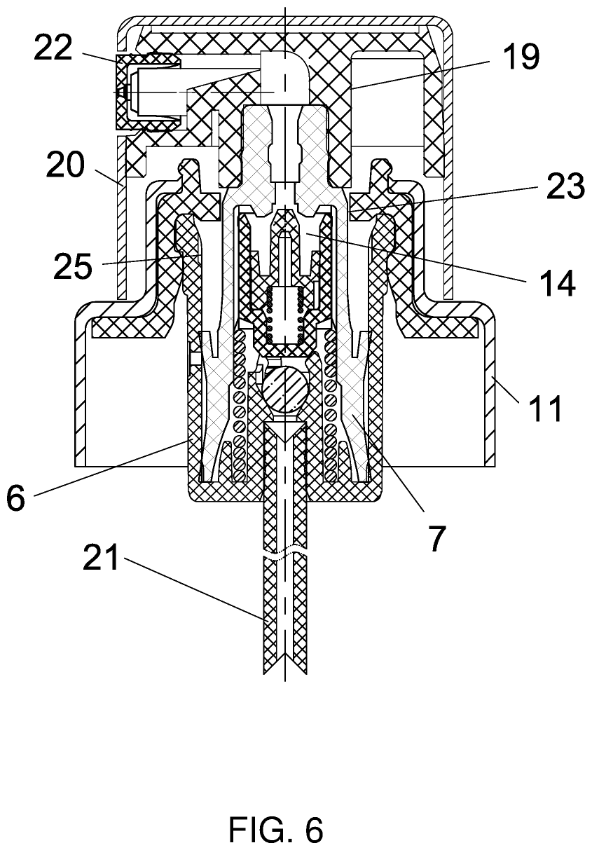

When the sealing space is fully filled with the liquid, the head assembly is pressed, and the sealing space gradually become smaller while the preloading piston assembly moves down. In this case, there is a pressure in the liquid, and all parts that are in contact with the liquid are under a pressure. When the pressure on the second piston 2 exceeds the pre-pressure of the second spring 5, the second piston 2 moves away from the water outlet channel 16 of the first piston 7, to open the water outlet channel 16. In this case, the liquid enters the head assembly through the water outlet channel 16 and is sprayed outward from the nozzle 22. In this case, as shown in FIG. 3 and FIG. 6, because the liquid in the container 100 is reduced, the vacuum is formed. While the preloading piston assembly moves down, the external air enters the container 100 through the exhaust hole 18 of the main body 6 from a gap 23 between the collar piece 4 and the first piston 7, and the air intake slot 25, to ensures that the pressure in the container 100 is consistent with that of the external environment and enable a continuous usage function of the pump body.

As shown in FIG. 3, the invention further provides a container 100. The container 100 includes a bottle 24, and the pre-compression pump is mounted on the bottle 24.

A suction pipe of the pre-compression pump is disposed in the bottle 24, and the exhaust hole 18 on the main body 6 is connected to the inner cavity of the bottle 24, to replenish the air in the external environment into the bottle 24 when the liquid in the bottle 24 is reduced, and enable functions of the pre-compression pump. A bayonet with a reduced size is disposed at a top of the bottle 24, the main body 6 is mounted in the bayonet, and the collar piece 4 is fixedly mounted on an outer part of the bayonet. A fixing sleeve 11 that clamps and fastens the collar piece 4 in the bayonet is coated at an outer ring of the bayonet, to prevent the pre-compression pump from falling off from the bottle 24 and loosening.

While the invention has been described in terms of preferred embodiments, those skilled in the art will recognize that the invention can be practiced with modifications within the spirit and scope of the appended claims.

What is claimed is:

1. A pre-compression pump capable of reducing height and preventing seepage, comprising:
a main body;
a first piston assembly that is movably mounted in an inner part of the main body; and
a head assembly that is disposed on a top of the first piston assembly,
wherein a water storage sump is disposed between the main body and the first piston assembly, a water outlet channel is disposed in an inner part of the first piston assembly, and the water outlet channel is connected to the water storage sump and a nozzle of the head assembly; and
the pre-compression pump further comprises a second piston that is disposed in the inner part of the first piston assembly, and a second spring that is supported between the second piston and the first piston assembly, and the second piston has an ejector pin portion that is used to seal the water outlet channel.

2. The pre-compression pump of claim 1, wherein the first piston assembly comprises a first piston that is movably disposed in the inner part of the main body, a spring holder that is mounted in an inner part of the first piston, and a first spring that is supported between the main body and the spring holder, and space between the first piston and the main body is the water storage sump; and
the second piston is movably disposed in the spring holder, the second spring is supported between the spring holder and the second piston, space between an upper side of the second piston and the first piston is a variable pressure silo, and the variable pressure silo is connected to the water storage sump.

3. The pre-compression pump of claim 2, wherein space between an underside of the second piston and the spring holder is a compression silo, the second piston comprises an internal elastic extension portion that extends outward, an outer edge of the internal elastic extension portion is in contact with an inner wall of the spring holder, to seal the compression silo.

4. The pre-compression pump of claim 2, wherein a side wall of the main body is provided with an exhaust hole, an outer edge of a bottom of the first piston extends outward to form a lower elastic extension portion that is used to seal the water storage sump, an exhaust adjusting rib that is disposed beneath the lower elastic extension portion is disposed in the inner part of the main body, and when moving downward and touching the exhaust adjusting rib, the lower elastic extension portion is deformed, to discharge air in an inner part of the water storage sump to the outside.

5. The pre-compression pump of claim 4, wherein a top of the main body is provided with an open, a collar piece is fastened and mounted in the open, the collar piece is sleeved in a center hole on the first piston, the first piston has a tapered segment of which size increases from top to bottom, and the center hole is in contact with the tapered segment to form a line seal.

6. The pre-compression pump of claim 5, wherein an outer edge of the top of the first piston expands outward to form an upper elastic extension portion, an outer edge of the upper elastic extension portion is in contact with an inner wall of the main body for sealing, an air intake slot is disposed at the top of the main body, and the upper elastic extension portion moves downward to the air intake slot with the first piston, to allow outside air to enter the exhaust hole.

7. The pre-compression pump of claim 2, wherein the water outlet channel is disposed in the inner part of the first piston and above the second piston, the ejector pin portion is disposed at a top of the second piston, at least one step is disposed at one end, close to the second piston, of the water outlet channel, a size of the ejector pin portion increases from top to bottom, and an edge of each step is in contact with the ejector pin portion, to form a line seal.

8. The pre-compression pump of claim 1, wherein the main body has a water inlet channel that is connected to the water storage sump, a one-way ball valve is disposed at a top of the water inlet channel and a suction pipe is connected to a bottom of the water inlet channel, an outer periphery of the one-way ball valve is enclosed by at least three limiting ribs that are disposed at intervals, and the one-way ball valve moves up and down in space that is enclosed by the limiting ribs.

9. A container, comprising a bottle and a pre-compression pump mounted on the bottle.

10. The container of claim 9, wherein the bottle has a bayonet, the main body is mounted in an inner part of the bayonet, and the collar piece is fixedly mounted on the top of the main body, and a fixing sleeve that clamps and fastens the collar piece in the bayonet is coated at an outer ring of the bayonet.
